(19) United States
(12) Patent Application Publication
(10) Pub. No.: US 2025/0348099 A1
(43) Pub. Date: Nov. 13, 2025

(54) LOW DROPOUT VOLTAGE REGULATOR HAVING LOW POWER MODE

(71) Applicant: SigmaStar Technology Ltd., Xiamen (CN)

(72) Inventors: Jian LI, Shanghai (CN); Kai SUN, Shanghai (CN); Xing Wang ZHANG, Shanghai (CN)

(21) Appl. No.: 18/971,186

(22) Filed: Dec. 6, 2024

(30) Foreign Application Priority Data
May 10, 2024 (CN) 202410578295.4

(51) Int. Cl. G05F 1/59; G05F 1/575

(52) U.S. Cl. CPC G05F 1/59; G05F 1/575

(57) ABSTRACT

A low-dropout regulator includes a control circuit and a voltage regulator circuit. The control circuit generates a plurality of bypass control signals according to a first output voltage on an output node and a bypass mode signal, and generates a plurality of power control signals according to the first output voltage and a low power mode signal. The voltage regulator circuit reduces a value of a current flowing through the output mode according to the plurality of power control signals, and adjusts a power supply voltage according to the plurality of bypass control signals to generate the first output voltage, or transmits the power supply voltage to the output node to output the power supply voltage as the first output voltage.

This application claims the benefit of China application Serial No. CN202410578295.4, filed on May 10, 2024, the subject matter of which is incorporated herein by reference.

### BACKGROUND OF THE INVENTION

### Field of the Invention

The present application relates to a low-dropout regulator, and more particularly, to a low-dropout regulator having a low power mode.

### Description of the Related Art

The demand of low power applications is becoming increasingly popular. In a current chip device, if a power supply corresponding to a general-purpose input/output (GPIO) interface is able to support a low power mode, the chip device can provide greater advantages. However, most low-dropout regulators merely support a normal mode providing a large load current, and are inapplicable to requirements of low power-related applications.

### SUMMARY OF THE INVENTION

In some embodiments, it is an object of the present application to provide a low-dropout regulator having a lower power mode so as to improve the issues of the prior art.

In some embodiments, a low-dropout regulator includes a control circuit and a voltage regulator circuit. The control circuit generates a plurality of bypass control signals according to a first output voltage on an output node and a bypass mode signal, and generates a plurality of power control signals according to the first output voltage and a low power mode signal. The voltage regulator circuit reduces a value of a current flowing through the output mode according to the plurality of power control signals, and selectively adjusts a power supply voltage according to the plurality of bypass control signals to generate the first output voltage.

Features, implementations and effects of the present application are described in detail in preferred embodiments with the accompanying drawings below.

### BRIEF DESCRIPTION OF THE DRAWINGS

To better describe the technical solution of the embodiments of the present application, drawings involved in the description of the embodiments are introduced below. It is apparent that, the drawings in the description below represent merely some embodiments of the present application, and other drawings apart from these drawings may also be obtained by a person skilled in the art without involving inventive skills.

FIG. 1 is a schematic diagram of a low-dropout regulator according to some embodiments of the present application;

FIG. 2 is a schematic diagram of the control circuit in FIG. 1 according to some embodiments of the present application;

FIG. 3 is a schematic diagram of the level shifter in FIG. 2 according to some embodiments of the present application;

FIG. 4 is a schematic diagram of the voltage regulator circuit in FIG. 1 according to some embodiments of the present application;

FIG. 5 is a schematic diagram of the bias-stage circuit in FIG. 4 according to some embodiments of the present application;

FIG. 6 is a schematic diagram of the input-stage circuit in FIG. 4 according to some embodiments of the present application;

FIG. 7A is a schematic diagram of a first part of the output-stage circuit in FIG. 4 according to some embodiments of the present application; and

FIG. 7B is a schematic diagram of a second part of the output-stage circuit in FIG. 4 according to some embodiments of the present application.

### DETAILED DESCRIPTION OF THE INVENTION

All terms used in the literature have commonly recognized meanings. Definitions of the terms in commonly used dictionaries and examples discussed in the disclosure of the present application are merely exemplary, and are not to be construed as limitations to the scope or the meanings of the present application. Similarly, the present application is not limited to the embodiments enumerated in the description of the application.

The term “coupled” or “connected” used in the literature refers to two or multiple elements being directly and physically or electrically in contact with each other, or indirectly and physically or electrically in contact with each other, and may also refer to two or more elements operating or acting with each other. As given in the literature, the term “circuit” may be a device connected by at least one transistor and/or at least one active element by a predetermined means so as to process signals.

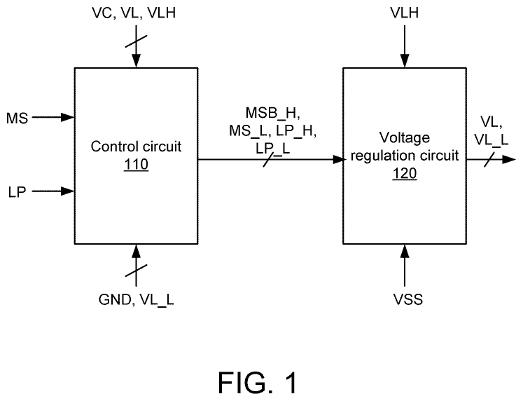

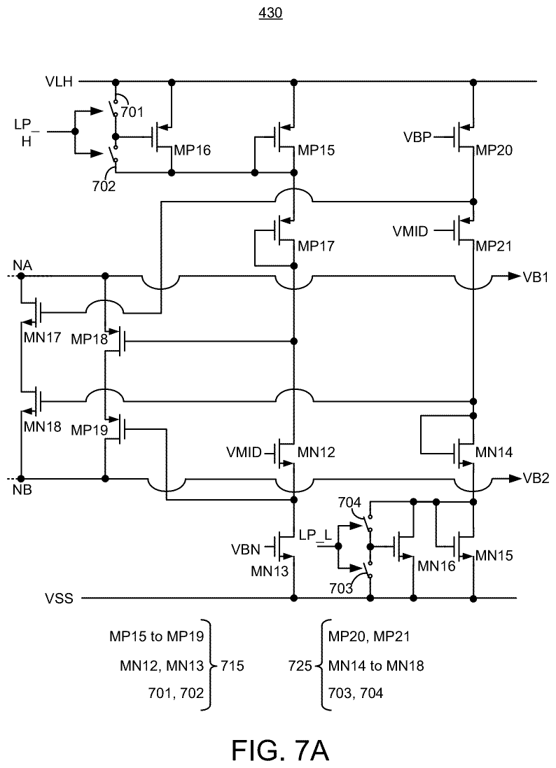

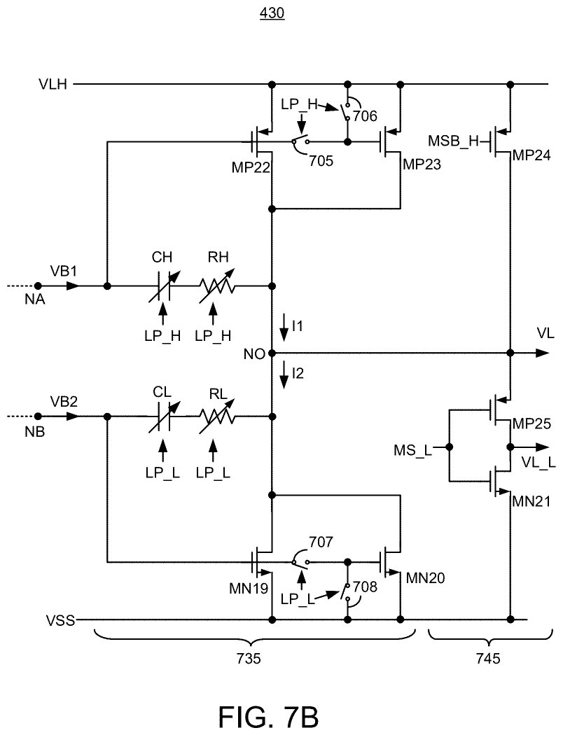

FIG. 1 shows a schematic diagram of a low-dropout regulator 100 according to some embodiments of the present application. In some embodiments, the low-dropout regulator 100 is applicable to an integrated circuit having a general-purpose input/output (GPIO). In some embodiments, the low-dropout regulator 100 includes a control circuit 110 and a voltage regulator circuit 120. The control circuit 110 is operable to generate multiple bypass control signals MS_L and MSB_H according to an output voltage VL on an output node (for example, the output node NO shown in FIG. 7B) and a bypass mode signal MS, and generate multiple power control signals LP_L and LP_H according to the output voltage VL and a low power mode signal LP.

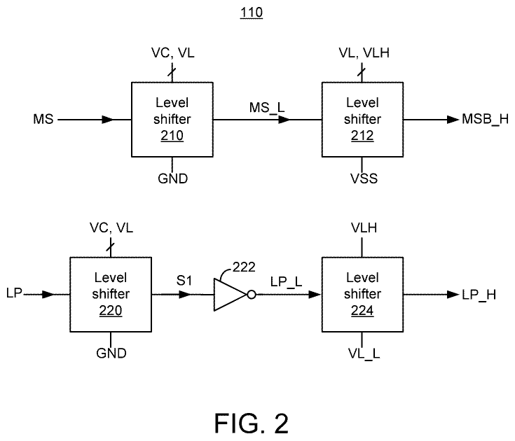

More specifically, in some embodiments, the control circuit 110 may convert a level of the bypass mode signal MS according to a core voltage VC and the output voltage VL to generate the bypass control signal MS_L, and generate the bypass control signal MSB_H according to the output voltage VL, a power supply voltage VLH and the bypass control signal MS_L. Similarly, in some embodiments, the control circuit 110 may convert a level of the low power mode signal LP according to the core voltage VC and the output voltage VL to generate the power control signal LP_L, and generate the power control signal LP_H according to the output voltage VL, the power supply voltage VLH and the power control signal LP_L. Associated details of the configuration of the control circuit 110 are to be described with reference to FIG. 2 below.

In some embodiments, the core voltage VC may be, for example but not limited to, a main power supply voltage used by a digital circuit in a system. In some embodiments, the power supply voltage VLH may be, for example but not limited to, a power supply voltage provided via a GPIO interface. The voltage regulator circuit 120 may selectively operate in a low power mode or a normal mode according to the plurality of power control signals LP_L and LP_H, and may selectively operate in a bypass mode or a voltage regulation mode according to the plurality of bypass control signals MS_L and MSB_H. In other words, according to the plurality of power control signals LP_L and LP_H and according to the plurality of bypass control signals MS_L and MSB_H, the voltage regulator circuit 120 is operable in a low power voltage regulation mode, a normal voltage regulation mode, a low power bypass mode or a normal bypass mode. In some embodiments, the power supply voltage VLH, the bypass mode signal MS, the core voltage VC, the low power mode signal LP and the correspondence among the various operation modes may be organized into a table below:

| | | | |
|---|---|---|---|
| VC = 0.8 V, | MS = 0 | LP = 0 | Low power voltage |
| VLH = 3.3 V | | | regulation mode |
| (high power supply | | LP = 1 | Normal voltage |
| voltage) | | | regulation mode |
| VC = 0.8 V, | MS = 1 | LP = 0 | Low power bypass |
| VLH = 1.8 V | | | mode |
| (low power supply | | LP = 1 | Normal bypass mode |
| voltage) | | | |
| VC off | MS = 0 | LP = 0 | Low power voltage |
| | | | regulation mode |

In the above, when the core voltage VC is 0.8 V and the power supply voltage is 3.3 V, the low-dropout regulator 100 operates in a high power supply voltage environment. In this case, the bypass mode signal MS is logic 0, such that the low-dropout regulator 100 operates in the voltage regulation mode so as to adjust the power supply voltage VLH to generate the output voltage VL. Moreover, if the low power mode signal LP is logic 0, the low-dropout regulator 100 further operates in the low power mode, such that the low-dropout regulator 100 operates in the low power voltage regulation mode. Alternatively, if the low power mode signal LP is logic 1, the low-dropout regulator 100 operates in the normal mode (in which the low-dropout regulator 100 has a higher power consumption), such that the low-dropout regulator 100 operates in the normal voltage regulation mode.

On the other hand, when the core voltage VC is 0.8 V and the power supply voltage is 1.8 V, the low-dropout regulator 100 operates in a low power supply voltage environment. In this case, the bypass mode signal MS is logic 1, such that the low-dropout regulator 100 operates in the bypass mode so as to output the power supply voltage VLH as the output voltage VL. Moreover, if the low power mode signal LP is logic 0, the low-dropout regulator 100 further operates in the low power mode, such that the low-dropout regulator 100 operates in the low power bypass mode. Alternatively, if the low power mode signal LP is logic 1, the low-dropout regulator 100 further operates in the normal mode, such that the low-dropout regulator 100 operates in the normal bypass mode. If the core voltage VC is turned off (or disconnected abruptly), the bypass mode signal MS switches to logic 0 and the low power mode signal LP switches to logic 0, such that the low-dropout regulator 100 operates in the low power voltage regulation mode. It should be noted that the above numerical values of the voltages in the table above are merely examples, and the present application is not limited to these examples. Associated details of the configuration of the voltage regulator circuit 120 are to be described with reference to FIG. 2 below.

In FIG. 1, the low-dropout regulator 100 may further generate an output voltage VL_L, the control circuit 110 further receives a ground voltage GND and the output voltage VL_L, and the voltage regulator circuit 120 further receives a ground voltage VSS. In some embodiments, the ground voltage GND may be a reference ground voltage relative to the core voltage VC. In some embodiments, the output voltage VL_L may be a reference ground voltage relative to the power supply voltage VLH. In some embodiments, the ground voltage VSS may be a reference ground voltage relative to the power supply voltage VLH.

FIG. 2 shows a schematic diagram of the control circuit 110 in FIG. 1 according to some embodiments of the present application. In some embodiments, the control circuit 110 includes a level shifter 210, a level shifter 212, a level shifter 220, an inverter 222 and a level shifter 224. The level shifter 210 converts a level of the bypass mode signal MS from the core voltage VC to the output voltage VL to generate the bypass control signal MS_L. The level shifter 212 selectively outputs the power supply voltage VLH or the ground voltage VSS as the bypass control signal MSB_H according to the bypass control signal MS_L. The level shifter 220 converts a level of the low power mode signal LP from the core voltage VC to the output voltage VL to generate a signal S1. The inverter 222 generates the power control signal LP_L according to the signal S1. The level shifter 224 converts a level of the power control signal LP_L from the output voltage VL to the power supply voltage VLH to generate the power control signal LP_H.

In some embodiments, each of the level shifter 210, the level shifter 220, the inverter 222 and the level shifter 224 may be implemented by a logic circuit and/or a switching circuit operating in different voltage domains. In some embodiments, each of the level shifter 210, the level shifter 220, the inverter 222 and the level shifter 224 may be implemented by a level shifter circuit in a circuit structure having a cross-coupled transistor pair; however, the present application is not limited to the examples above.

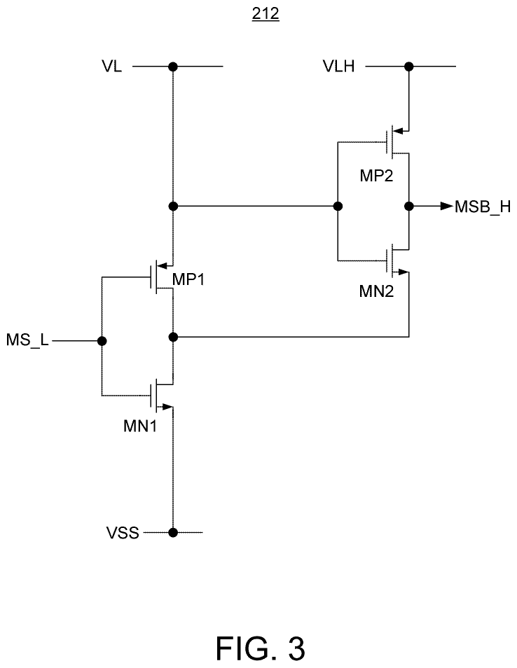

FIG. 3 shows a schematic diagram of the level shifter 212 in FIG. 2 according to some embodiments of the present application. In some embodiments, the level shifter 212 includes multiple transistors MP1, MP2, MN1 and MN2. The transistor MP1 and the transistor MN1 form an inverter, and are powered by the output voltage VL. The transistor MP2 and the transistor MN2 form another inverter, and are powered by the power supply voltage VLH. More specifically, a first terminal (for example, the source) of the transistor MP1 receives the output voltage VL and is coupled to a control terminal of the transistor MP2, a second terminal (for example, the drain) of the transistor MP1 is coupled to a first terminal (for example, the drain) of the transistor MN1, and a control terminal (for example, the gate) of the transistor MP1 receives the bypass control signal MS_L. A second terminal (for example, the source) of the transistor MN1 receives the ground voltage VSS, and a control terminal (for example, the gate) of the transistor MN1 receives the bypass control signal MS_L. A second terminal of the transistor MP2 is coupled to a first terminal of the transistor MN2 and outputs the bypass control signal MSB_H. A second terminal of the transistor MN2 is coupled to the first terminal of the transistor MN1, and a second terminal of the transistor MN2 is coupled to the first terminal of the transistor MP1.

With the configuration above, when the bypass control signal MS_L has a low logic level, the transistor MP1 is turned on and the transistor MN1 is turned off. In this case, the transistor MN2 is turned off and the transistor MP2 is turned on, so as to generate the bypass control signal MSB_H having a same level as the power supply voltage VLH. Alternatively, when the bypass control signal MS_L has a high logic level, the transistor MP1 is turned off and the transistor MN1 is turned on. In this case, the transistor MN2 is turned on, so as to generate the bypass control signal MSB_H having a same level as the ground voltage.

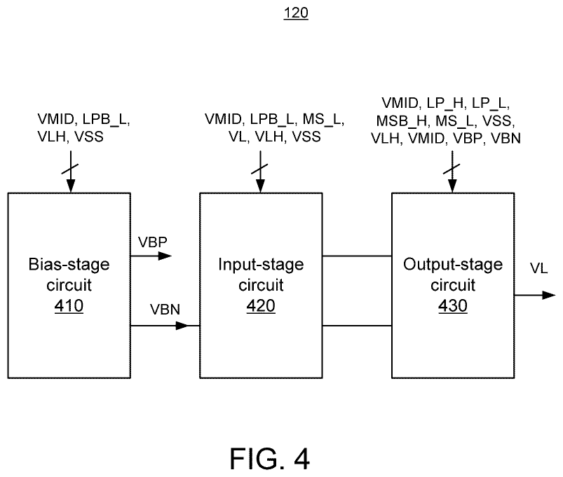

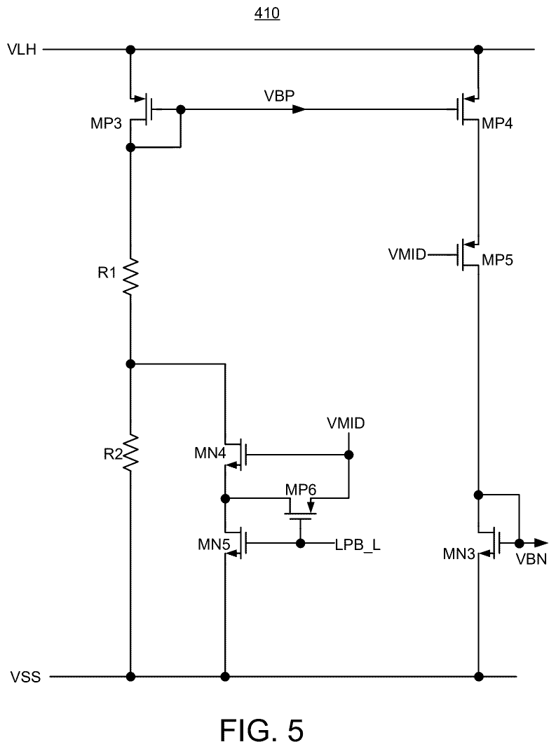

FIG. 4 shows a schematic diagram of the voltage regulator circuit 120 in FIG. 1 according to some embodiments of the present application. The voltage regulator circuit 120 includes bias-stage circuit 410, an input-stage circuit 420 and an output-stage circuit 430. The bias-stage circuit 410 generates a bias voltage VBP and a bias voltage VBN according to a reference voltage VMID and a control signal LPB_L. In some embodiments, the control signal LPB_L may be a signal logically inverted from the power control signal LP_L. The input-stage circuit 420 is biased by the bias voltage VBN, the power supply voltage VLH and the ground voltage VSS, selectively outputs the output voltage VL or the ground voltage VSS as a feedback voltage VFB (as shown in FIG. 5) according to the bypass control signal MS_L, and compares the reference voltage VMID with the feedback voltage VFB so as to regulate the output voltage VL. The voltage regulator circuit 120 is biased by the power supply voltage VLH, the ground voltage VSS, the reference voltage VMID, the bias voltage VPB and the bias voltage VBN, and adjusts an internal bias voltage according to the plurality of power control signals LP_H and LP_L so as to adjust a value of a current flowing through an output node NO in FIG. 7B, thereby generating the output voltage VL and the output voltage VL_L. In some embodiments, the voltage regulator circuit 120 further compensates an internal frequency thereof according to the plurality of power control signals LP_H and LP_L so as to ensure the stability of frequency response of circuits. Specific configuration details related the circuits above are described with the accompanying drawings below.

FIG. 5 shows a schematic diagram of the bias-stage circuit 410 in FIG. 4 according to some embodiments of the present application. The bias-stage circuit 410 includes multiple resistors R1 and R2, multiple transistors MP3, MP4, MP5 and MP6, and multiple transistors MN3, MN4 and MN5. A first terminal of the transistor MP3 receives the power supply voltage VLH, and a second terminal of the transistor MP3 is coupled to a control terminal of the transistor MP3, a first terminal of a resistor R1 and a control terminal of the transistor MP4 to generate the bias voltage VBP. A first terminal of the transistor MP4 receives the power supply voltage VLH, and a second terminal of the transistor MP4 is coupled to a first terminal of the transistor MP5. A second terminal of the transistor MP5 is coupled to a first terminal and a control terminal of the transistor MN3 to generate the bias voltage VBN, and a control terminal of the transistor MP5 receives the reference voltage VMID. A second terminal of the transistor MN3 receives the ground voltage VSS. A second terminal of the resistor R1 is coupled to a first terminal of the resistor R2 and a first terminal of the transistor MN4. A second terminal of the resistor R2 receives the ground voltage VSS. A second terminal of the transistor MN4 is coupled to a second terminal of the transistor MP6 and a first terminal of the transistor MN5, and a control terminal of the transistor MN4 is coupled to a first terminal of the transistor MP6 and receives the reference voltage VMID. A second terminal of the transistor MN5 receives the ground voltage VSS. A control terminal of the transistor MN5 and a control terminal of the transistor MP6 receive the control signal LPB_L.

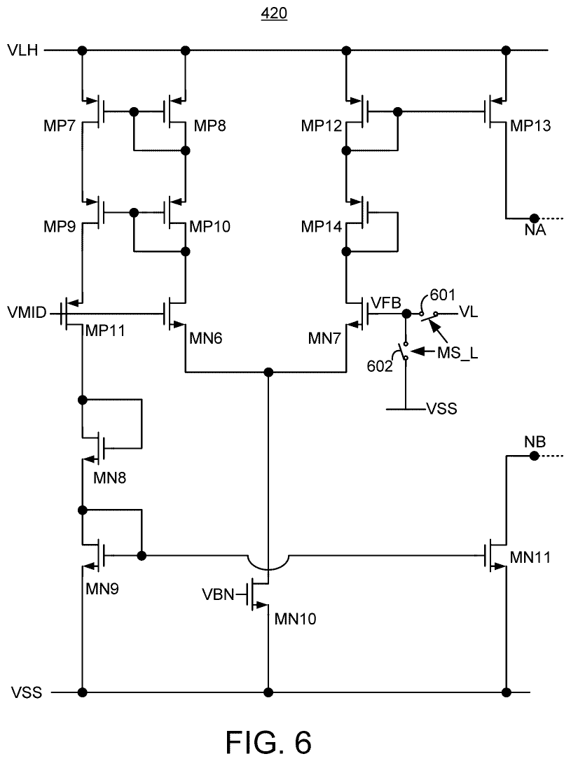

FIG. 6 shows a schematic diagram of the input-stage circuit 420 in FIG. 4 according to some embodiments of the present application. The input-stage circuit 420 includes multiple transistors MP7 to MP14, multiple transistors MN6 to MN11 and multiple switches 601 and 602.

More specifically, first terminals of the multiple transistors MP7, MP8, MP12 and MP13 receive the power supply voltage VLH. A second terminal of the transistor MP7 is coupled to a first terminal of the transistor MP9, and a control terminal of the transistor MP7 is coupled to a control terminal and a second terminal of the transistor MP8 and a first terminal of the transistor MP10. A second terminal of the transistor MP9 is coupled to a first terminal of the transistor MP11, and a control terminal of the transistor MP9 is coupled to a control terminal and a second terminal of the transistor MP10 and a first terminal of the transistor MN6. A second terminal of the transistor MP11 is coupled to a first terminal and a control terminal of the transistor MN8, and a control terminal of the transistor MP11 receives the reference voltage VMID. A second terminal of the transistor MN8 is coupled to a first terminal and a control terminal of the transistor MN9 and a control terminal of the transistor MN11, and a second terminal of the transistor MN9 receives the ground voltage VSS. A control terminal of the transistor MN6 receives the reference voltage VMID, and a second terminal of the transistor MN6 is coupled to a first terminal of the transistor MN10. A control terminal MN7 receives the feedback voltage VFB. A second terminal of the transistor MN7 is coupled to a first terminal of the transistor MN10. The switch 601 is selectively turned on according to the bypass control signal MS_L to output the output voltage VL as the feedback voltage VFB. The switch 602 is selectively turned on according to the bypass control signal MS_L to output the ground voltage VSS as the feedback voltage VFB. A control terminal of the transistor MN10 receives the bias voltage VBN, and a second terminal of the transistor MN10 receives the ground voltage VSS. A control terminal and a second terminal of the transistor MP12 are coupled to a control terminal of the transistor MP13 and a first terminal of the transistor MP14. A second terminal of the transistor MP13 is coupled to an output node NA. A second terminal and a control terminal of the transistor MP14 are coupled to a first terminal of the transistor MN7. A first terminal of the transistor MN11 is coupled to a node NB, and a second terminal of the transistor MN11 receives the ground voltage VSS.

With the configuration above, the input-stage circuit 420 is operable as a comparator. When operation is performed in a high power supply voltage mode, the switch 601 may be turned on according to the bypass control signal MS_L and the switch 602 may be turned off according to the bypass control signal MS_L. In this case, the output voltage VL is output via the switch 601 as the feedback voltage VFB, such that the input-stage circuit 420 may compare the reference voltage VMID with the feedback voltage VFB to adjust potentials on the node NA and the node NB (for example, a bias voltage VB1 and a bias voltage VB2 to be described below), thereby assisting in regulating the output voltage VL.

FIG. 7A shows a schematic diagram of a first part of the output-stage circuit 430 in FIG. 4 according to some embodiments of the present application. The first part of the output-stage circuit 430 includes multiple transistors MP15 to MP21, multiple transistors MN12 to MN18 and multiple switches 701 to 704. The multiple transistors MP15 to MP19, MN12 and MN13 and the multiple switches 701 and 702 operate as a current mirror circuit 715, and the multiple transistors MP20, MP21 and MN14 to MN18 and the multiple switches 703 and 704 operate as a current mirror circuit 725.

The current mirror circuit 715 may adjust the bias voltage VB1 on the node NA and the bias voltage VB2 on the node NB according to the power supply voltage VLH and the power control signal LP_H. More specifically, a first terminal of the transistor MP15 and a first terminal of the transistor MP16 receive the power supply voltage VLH, a second terminal of the transistor MP15 and a second terminal of the transistor MP16 are coupled to a first terminal of the transistor MP17, and a control terminal of the transistor MP15 is coupled to a second terminal of the transistor MP16. A control terminal of the transistor MP16 receives the power supply voltage VLH via the switch 701 or is coupled to a second terminal of the transistor MP16 via the switch 702. In other words, the switch 701 and the switch 702 are selectively turned on according to the power control signal LP_H, so as to turn on the transistor MP16 or turn off the transistor MP16 by using the power supply voltage VLH, thereby adjusting the bias voltage VB1. For illustration from another perspective, the transistor MP15 is a diode-connected transistor, and the transistor MP16 may be turned off according to the power supply voltage VLH transmitted via the switch 701, or is configured as a diode-connected transistor via the switch 702 so as to be turned on. A control terminal of the transistor MP17 is coupled to a second terminal of the transistor MP17, a first terminal of the transistor MN12 and a control terminal of the transistor MP18. A control terminal of the transistor MN12 receives the reference voltage VMID, and a second terminal of the transistor MN12 is coupled to a control terminal of the transistor MP19 and a first terminal of the transistor MN13. A second terminal of the transistor MN13 receives the ground voltage VSS, and a control terminal of the transistor MN13 receives the bias voltage VBN. A first terminal of the transistor MP18 is coupled to the node NA, and a second terminal of the transistor MP18 is coupled to a first terminal of the transistor MP19. A second terminal of the transistor MP19 is coupled to the node NB. With the configuration above, the transistor MP16 may be selectively turned on according to the power control signal LP_H, thereby adjusting a level of the node NA (that is, the bias voltage VB1) and a level of the node NB (that is, the bias voltage VB2).

Similarly, the current mirror circuit 725 may adjust the bias voltage VB1 and the bias voltage VB2 according to the ground voltage VSS and the power control signal LP_L. More specifically, a second terminal of the transistor MN15 and a second terminal of the transistor MN16 receive the ground voltage VSS, a first terminal of the transistor MN15 and a first terminal of the transistor MN16 are coupled to a second terminal of the transistor MN14, and a control terminal of the transistor MN15 is coupled to a second terminal of the transistor MN15. A control terminal of the transistor MN16 selectively receives the ground voltage VSS via the switch 703 or is coupled to a first terminal of the transistor MN16 via the switch 704. The switch 703 and the switch 704 may be selectively turned on according to the power control signal LP_L, so as to turn on the transistor MN16 or turn off the transistor MN16 by using the ground voltage VSS, thereby adjusting the bias voltage VB1 and the bias voltage VB2. That is to say, the transistor MN15 is a diode-connected transistor, and the transistor MN16 may be turned off according to the ground voltage VSS transmitted via the switch 703, or is configured as a diode-connected transistor via the switch 704 so as to be turned on.

A control terminal of the transistor MN14 is coupled to a first terminal of the transistor MN14, a second terminal of the transistor MP21 and a control terminal of the transistor MN18. A control terminal of the transistor MP21 receives the reference voltage VMID, and a first terminal of the transistor MP21 is coupled to a control terminal of the transistor MN17 and a second terminal of the transistor MP20. A first terminal of the transistor MP20 receives the power supply voltage VLH, and a control terminal of the transistor MP20 receives the bias voltage VBP. A first terminal of the transistor MN17 is coupled to the node NA, and a second terminal of the transistor MN17 is coupled to a first terminal of the transistor MN18. A second terminal of the transistor MN18 is coupled to the node NB. With the configuration above, the transistor MN16 may be selectively turned on according to the power control signal LP_L, thereby adjusting the bias voltage VB1 and the bias voltage VB2.

FIG. 7B shows a schematic diagram of a second part of the output-stage circuit 430 in FIG. 4 according to some embodiments of the present application. In continuation from FIG. 7A, in FIG. 7B, the output-stage circuit 430 further includes a second part, which includes multiple transistors MP22 to MP25, multiple transistors MN19 to MN21, multiple switches 705 to 708, multiple capacitors CH and CL, and multiple resistors RH and RL. The multiple transistors MP22 to MP23, MN19 and MN20, the multiple switches 705 to 708, the multiple capacitors CH and CL, and the multiple resistors RH and RL operate as a regulator circuit 735, and the multiple transistors MP24, MP25 and MN21 operate as a bypass circuit 745.

The regulator circuit 735 generates a current 11 according to the power control signal LP_H, the bias voltage VBP and the power supply voltage VLH, and generates a current 12 according to the power control signal LP_L, the bias voltage VBN and the ground voltage VSS. The value of the current flowing through the output node NO may be determined based on the current 11 and the current 12. More specifically, a first terminal of the transistor MP22 and a first terminal of the transistor MP23 receive the power supply voltage VLH, a second terminal of the transistor MP22 and a second terminal of the transistor MP23 are coupled to the output node NO and generate the current 11, and a control terminal of the transistor MP22 is coupled to the node NA to receive the bias voltage VB1. A control terminal of the transistor MP23 is coupled to a node via the switch 705 to receive the bias voltage VB1, or receives the power supply voltage VLH via the switch 706. In other words, the transistor MP22 and the transistor MP23 may generate the current 11 according to the power supply voltage VLH and the bias voltage VB1. The switch 705 and the switch 706 may be selectively turned on according to the power control signal LP_H, so as to turn on the transistor MP16 by using the bias voltage VB1 or turn off the transistor MP16 by using the power supply voltage VLH, thereby adjusting the current 11. The capacitor CH and the resistor RH are coupled between the node NA and the output node NO to perform frequency compensation. In some embodiments, the capacitor CH and the resistor RH are a Miller compensation circuit, wherein a capacitance value of the capacitor CH and/or a resistance value of the resistor RH may be adjusted according to the power control signal LP_H. For example, to enter a low power mode, the capacitance value of the capacitor CH and/or the resistance value of the resistor RH may be increased; conversely, to enter a normal mode, the capacitance value of the capacitor CH and/or the resistance value of the resistor RH may be decreased.

On the other hand, a second terminal of the transistor MN19 and a second terminal of the transistor MN20 receive the ground voltage VSS, a first terminal of the transistor MN19 and a first terminal of the transistor MN20 are coupled to the output node NO and generate the current 12, and a control terminal of the transistor MN19 is coupled to the node NB to receive the bias voltage VB2. A control terminal of the transistor MN20 is coupled to the node NB via the switch 707 to receive the bias voltage VB2, or receives the ground voltage VSS via the switch 708. In other words, the transistor MN19 and the transistor MN20 may generate the current 12 according to the ground voltage VSS and the bias voltage VB2. The switch 707 and the switch 708 may be selectively turned on according to the power control signal LP_L, so as to turn on the transistor MP19 by using the bias voltage VB2 or turn off the transistor MP19 by using the ground voltage VSS, thereby adjusting the current 12. The capacitor CL and the resistor RL are coupled between the node NB and the output node NO to perform frequency compensation. In some embodiments, the capacitor CL and the resistor RL are a Miller compensation circuit, wherein a capacitance value of the capacitor CL and/or a resistance value of the resistor RL may be adjusted according to the power control signal LP_L. For example, to enter a low power mode, the capacitance value of the capacitor CL and/or the resistance value of the resistor RL may be increased; conversely, to enter a normal mode, the capacitance value of the capacitor CL and/or the resistance value of the resistor RL may be decreased.

The bypass circuit 745 transmits the power supply voltage VLH to the output node NO according to the bypass control signal MSB_H, so as to output the power supply voltage VLH as the output voltage VL (that is, a bypass mode), and outputs the ground voltage VSS as the output voltage VL_L or outputs the output voltage VL as the output voltage VL_L according to the bypass control signal MS_L. More specifically, a first terminal of the transistor MP24 receives the power supply voltage VLH, a second terminal of the transistor MP24 is coupled to the output node NO to generate the output voltage VL, and a control terminal of the transistor MP24 receives the bypass signal MSB_H. A first terminal of the transistor MP25 is coupled to the output node NO, a second terminal of the transistor MP25 is coupled to a first terminal of the transistor MN21 and generates the output voltage VL_L, and a control terminal of the transistor MP25 and a control terminal of the transistor MN21 receive the bypass signal MS_L. A second terminal of the transistor MN21 receives the ground voltage VSS.

When the low-dropout regulator 100 operates in a high power supply voltage environment, as described in the table above, the bypass mode signal MS is logic 0, such that the bypass control signal MS_L is at a low logic level and the bypass control signal MSB_H is at a high logic level. In this case, the transistor MP24 and the transistor MN21 are turned off, and the transistor MP25 is turned on to output the output voltage VL as the output voltage VL_L. On the other hand, the switch 601 is turned on and the switch 602 is turned off, such that the output voltage VL is output as the feedback voltage VFB. Thus, the input-stage circuit 420 and the output-stage circuit 430 form a negative feedback circuit, thereby generating the power supply voltage VLH to generate the output voltage VL (that is, the normal voltage regulation mode in the table above).

Further, when the low-dropout regulator 100 operates in a high power supply voltage environment and the low power mode signal LP is logic 0, the multiple transistors MP15, MP16, MP22, MN15, MN16 and MN19 are turned on, and the multiple transistors MP23 and MN20 are turned off. In this case, the bias voltage VB1 and the bias voltage VB2 are adjusted, such that the current 11 and the current 12 obtained from mirroring of the current mirror circuit 715 and the current mirror circuit 725 are decreased. Thus, the value of the current flowing through the node NO can be reduced to further reduce the overall current consumption of the low-dropout regulator 100, such that operation in the low power voltage regulation mode can be performed. Meanwhile, the capacitor CH, the resistor RH, the capacitor CL and the resistor RL are respectively adjusted by the power control signal LP_H and the power control signal LP_L to perform corresponding frequency compensation. Conversely, when the low-dropout regulator 100 operates in a high power supply voltage environment and the low power mode signal LP is logic 1, the multiple transistors MP15, MP22, MP23, MN15, MN19 and MN20 are turned on, and the multiple transistors MP16 and MN16 are turned off. In this case, the bias voltage VB1 and the bias voltage VB2 are adjusted, such that the current 11 and the current 12 obtained from mirroring of the current mirror circuit 715 and the current mirror circuit 725 are increased, and thus operation in the normal voltage regulation mode can be performed. Similarly, the capacitor CH, the resistor RH, the capacitor CL and the resistor RL are respectively adjusted by the power control signal LP_H and the power control signal LP_L to perform corresponding frequency compensation.

It is known from the above that, as the number of transistors turned on in the current mirror circuit 715 (or the current mirror circuit 725) according to the first power control signal increases, the number of transistors turned on in the regulator circuit 735 according to the power control signal LP_H (or the power control signal LP_L) decreases and the value of the current flowing through the output node NO gets lower. In other words, the low-dropout regulator 100 is capable of setting internal circuit configurations (that is, configurations of the transistors and switches in the current mirror circuit 715, the current mirror circuit 725 and the regulator circuit 735) according to the low power mode signal LP to determine whether to reduce the value of the current flowing through the output node, so as to adapt to applications having a low power mode.

Similarly, when the low-dropout regulator 100 operates in a low power supply voltage environment, as described in the table above, the bypass mode signal MS is logic 1, such that the bypass control signal MS_L is at a high logic level and the bypass control signal MS_H is at a low logic level. In this case, the transistor MP25 is turned off, the transistor MP24 is turned on to output the power supply voltage VLH as the output voltage VL (that is, the bypass mode), and the transistor MN21 is turned on to output the ground voltage VSS as the output voltage VL_L. On the other hand, the switch 601 is turned off and the switch 602 is turned on, such that the ground voltage VSS is output as the feedback voltage VFB. Thus, the negative feedback circuit formed by the input-stage circuit 420 and the output-stage circuit 430 adjusts the bias voltage VB1 to turn on the transistor MP22 and the transistor MP23, so as to assist the transistor MP24 to transmit the power supply voltage VLH to the output node NO (equivalent to enhancing the turning on ability of the transistor MP24).

Further, when the low-dropout regulator 100 operates in a low power supply voltage environment and the low power mode signal LP is logic 0, the multiple transistors MP15, MP16, MP22, MN15, MN16 and MN19 are turned on, and the multiple transistors MP23 and MN20 are turned off. In this case, the bias voltage VB1 and the bias voltage VB2 are adjusted, such that the current 11 and the current 12 obtained from mirroring of the current mirror circuit 715 and the current mirror circuit 725 are decreased. Thus, the value of the current flowing through the node NO can be reduced to further reduce the overall current consumption of the low-dropout regulator 100, and thus operation in the low power bypass mode can be performed. Meanwhile, the capacitor CH, the resistor RH, the capacitor CL and the resistor RL are respectively adjusted by the power control signal LP_H and the power control signal LP_L to perform corresponding frequency compensation. Conversely, when the low-dropout regulator 100 operates in a low power supply voltage environment and the low power mode signal LP is logic 1, the multiple transistors MP15, MP22, MP23, MN15, MN19 and MN20 are turned on, and the multiple transistors MP16 and MN16 are turned off. In this case, the bias voltage VB1 and the bias voltage VB2 are adjusted, such that the current 11 and the current 12 obtained from mirroring of the current mirror circuit 715 and the current mirror circuit 725 are increased, and thus operation in the normal bypass mode can be performed. Similarly, the capacitor CH, the resistor RH, the capacitor CL and the resistor RL may be respectively adjusted by the power control signal LP_H and the power control signal LP_L to perform corresponding frequency compensation.

It should be noted that the configuration details of the voltage regulator circuit 120 above are examples, and are not to be construed as limitation to the present application. Various types of voltage regulator circuits 120 capable of correspondingly switching circuit configurations based on low power mode requirements are to be encompassed within the scope of the present application.

In conclusion, the low-dropout regulator provided according to some embodiments of the present application can set internal circuit configurations thereof (for example, including settings such as a current mirror circuit and settings for frequency compensation) based on a low power mode signal, so that the low-dropout regulator is capable of reducing overall static current consumption based on the low power mode, thereby adapting to low power mode-related applications.

While the present application has been described by way of example and in terms of the preferred embodiments, it is to be understood that the disclosure is not limited thereto. Various modifications may be made to the technical features of the present application by a person skilled in the art on the basis of the explicit or implicit disclosures of the present application. The scope of the appended claims of the present application therefore should be accorded with the broadest interpretation so as to encompass all such modifications.

What is claimed is:

1. A low-dropout regulator, comprising:
a control circuit, generating a plurality of bypass control signals according to a first output voltage on an output node and a bypass mode signal, and generating a plurality of power control signals according to the first output voltage and a low power mode signal; and
a voltage regulator circuit, reducing a value of a current flowing through the output node according to the plurality of power control signals, and selectively adjusting a power supply voltage according to the plurality of bypass control signals to generate the first output voltage.

2. The low-dropout regulator according to claim 1, wherein the control circuit converts a level of the bypass mode signal according to a core voltage and the first output voltage to generate a first bypass control signal among the plurality of bypass control signals, and generates a second bypass control signal among the plurality of bypass control signals according to the first output voltage, the power supply voltage and the first bypass control signal.

3. The low-dropout regulator according to claim 1, wherein the control circuit comprises:
a first level shifter, converting a level of the bypass mode signal from a core voltage to the first output voltage to generate a first bypass control signal among the plurality of bypass control signals; and
a second level shifter, selectively outputting the power supply voltage or a ground voltage as a second bypass control signal among the plurality of bypass control signals according to the first bypass control signal.

4. The low-dropout regulator according to claim 1, wherein the control circuit converts a level of the low power mode signal according to a core voltage and the first output voltage to generate a first power control signal among the plurality of power control signals, and generates a second power control signal among the plurality of power control signals according to the first output voltage, the power supply voltage and the first power control signal.

5. The low-dropout regulator according to claim 1, wherein the control circuit comprises:
a first level shifter, converting a level of the low power mode signal from a core voltage to the first output voltage to generate a first signal;
an inverter, generating a first power control signal among the plurality of power control signals according to the first signal; and
a second level shifter, converting a level of the first power control signal from the first output voltage to the power supply voltage to generate a second power control signal among the plurality of power control signals.

6. The low-dropout regulator according to claim 1, wherein the voltage regulator circuit further adjusts a compensation frequency of the voltage regulator circuit according to the plurality of power control signals.

7. The low-dropout regulator according to claim 1, wherein the voltage regulator circuit comprises:
an input-stage circuit, selectively outputting the first output voltage or a ground voltage as a feedback voltage according to a first bypass control signal among the plurality of bypass control signals, and comparing a reference voltage with the feedback voltage to regulate the first output voltage.

8. The low-dropout regulator according to claim 1, wherein the voltage regulator circuit comprises:
a first current mirror circuit, adjusting a first bias voltage and a second bias voltage according to the power supply voltage and a first power control signal among the plurality of power control signals;
a second current mirror circuit, adjusting the first bias voltage and the second bias voltage according to a ground voltage and a second power control signal among the plurality of power control signals;
a regulator circuit, generating a first current according to the first power control signal, the first bias voltage and the power supply voltage, and generating a second current according to the second power control signal, the second bias voltage and the ground voltage, wherein a value of a current flowing through the output node is determined based on the first current and the second current; and
a bypass circuit, transmitting the power supply voltage to the output node according to a first bypass control signal among the plurality of bypass control signals, and outputting the ground voltage as a second output voltage according to a second bypass control signal among the plurality of bypass control signals, or outputting the first output voltage as the second output voltage.

9. The low-dropout regulator according to claim 8, wherein as a number of transistors turned on in the first current mirror circuit according to the first power control signal increases, a number of transistors turned on in the regulator circuit according to the first power control signal decreases and the value of the current flowing through the output node gets lower.

10. The low-dropout regulator according to claim 8, wherein the first current mirror circuit comprises:
a plurality of transistors; and
a plurality of switches, coupled to a first transistor among the plurality of transistors, and selectively turned on according to the first power control signal to turn off the first transistor by using the power supply voltage.

11. The low-dropout regulator according to claim 10, wherein a second transistor among the plurality of transistors is a diode-connected transistor.

12. The low-dropout regulator according to claim 10, wherein the plurality of switches comprise:
a first switch, selectively turned on according to the first power control signal to turn off the first transistor by using the power supply voltage; and
a second switch, selectively turned on according to the first power control signal to configure a second transistor among the plurality of transistors as a diode-connected transistor.

13. The low-dropout regulator according to claim 8, wherein the regulator circuit comprises:
a plurality of transistors, generating the first current according to the power supply voltage and the first bias voltage; and
a plurality of switches, selectively turned on according to the first power control signal to turn off a first transistor among the plurality of transistors by using the power supply voltage.

14. The low-dropout regulator according to claim 13, wherein a second transistor among the plurality of transistors is a diode-connected transistor.

15. The low-dropout regulator according to claim 13, wherein the plurality of switches comprise:
a first switch, selectively turned on according to the first power control signal to turn off the first transistor by using the power supply voltage; and
a second switch, selectively turned on according to the first power control signal to configure a second transistor among the plurality of transistors as a diode-connected transistor.
